(19) United States
(12) Patent Application Publication
(10) Pub. No.: US 2010/0079865 A1
(43) Pub. Date: Apr. 1, 2010

(54) Near-to-eye scanning display with exit-pupil expansion

(75) Inventors: Pasi Saarikko, Espoo (FI); Pekka Ayras, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/286,112

(22) Filed: Sep. 26, 2008

(51) Int. Cl. G02B 5/18

(52) U.S. Cl. 359/566

(57) ABSTRACT

The specification and drawings present a new apparatus and method for near-to-eye (e.g., retinal) displaying with exit-pupil expansion using a scanning component (e.g., a scanning mirror) and an exit-pupil expander (e.g., diffractive exit-pupil expander) for providing a retinal scanning display with a large exit pupil.

### TECHNICAL FIELD

The present invention relates generally to display devices and, more specifically, to near-to-eye-display (NED) technology for providing a retinal scanning display with a large exit pupil.

### BACKGROUND ART

Three key features for all portable electric consumer products are low weight, small size and long operation time. The requirement of low weight and small size are particularly important for any device to be used as an eye wear, such as a near-to-eye display (NED). Moreover, the requirement of low power consumption is paramount to any multimedia device in the mobile context.

The source image of a NED is generated by using two main techniques: active dot matrix (e.g. liquid crystal display panel), or a scanning-beam light source (c.f., cathode-ray tube, CRT). The source image is relayed to the viewer's eye(s) using an optical setup that allows the viewer to perceive the source image as a virtual display.

The source image may be formed by scanning an optical beam (one pixel) across the image area with high frequency; the light beam can be mono-color or RGB (red-green-blue) composition. When the scanning frequency is high enough, the viewer perceives the scanning beam as a single image (the traditional CRT is based on this). In retinal scanning displays the image is scanned ‘directly’ on the retina, whereas in CRTs the image is scanned on the phosphorous surface of the vacuum tube. Current retinal scanning displays use an LED or a laser light source to generate the input beam to the viewer's eye(s). The angle of the input beam is scanned using a micro-mechanical mirror (or by other means) to generate the perception of a virtual display.

The functionality of an exit-pupil expander (EPE) and its variations are described in several publications, e.g. by Tapani Levola “Methods and System got Beam Expansion in a Display Device”, U.S. Pat. No. 7,206,107, or by Tapani Levola “Diffractive Optics for Virtual Reality Displays”, published in Journal of the Society for Information Display, 14 (2006) 5, pp. 467-475. Typically an EPE plate is utilized in conjunction with an LCD panel and a suitable imaging optics to form virtual image at infinite viewing distance. This approach requires somewhat large size of the imaging optics and the related illumination system. Moreover, use of LCD requires always-on illumination of the LCD panel, i.e., black pixels are formed by blocking light, resulting in constant power consumption regardless of the information content of the display.

### DISCLOSURE OF THE INVENTION

According to a first aspect of the invention, an apparatus, comprises: a scanning component, configured to scan one or more optical beams time modulated and synchronized with video information and to provide one or more input optical beams; and an exit-pupil expander comprising a thin structure with a plurality of diffractive elements disposed on the thin structure, responsive to the one or more optical beams, configured to provide one or more output optical beams using one or more diffractive elements from that plurality of diffractive elements, so as to provide one or more scanning near-to eye image displays with an expanded exit pupil for providing the video information.

According further to the first aspect of the invention, the one or more optical beams may be provided by corresponding one or more light sources. Further, the one or more light sources and the scanning component may be located on opposite sides of the exit-pupil expander. Still further, the one or more light sources may be provided using one or more optical fibers with corresponding one or more collimators. Yet still further, the one or more light sources may be provided using one or more light emitting diodes, or one or more lasers.

Further according to the first aspect of the invention, the one or more output optical beams may have the expanded exit pupil in one or two dimensions relative to the input optical beam.

Still further according to the first aspect of the invention, the scanning element may be a scanning mirror, configured to provide one or more input optical beams by reflecting the one or more optical beams.

According further to the first aspect of the invention, the apparatus may further comprise: a quarter-wavelength plate placed between the exit-pupil expander and the scanning mirror, configured to minimize light losses of the one or more optical beams coupled to the exit-pupil expander for providing the one or more scanning near-to eye image displays with the expanded exit pupil. Still further, the apparatus may further comprise: a polarization beam splitter, configured to further minimize the light losses and placed between the quarter-wavelength plate and the exit-pupil expander, wherein the one or more optical beams are provided to the scanning mirror and to the exit-pupil expander using the polarization beam splitter and the quarter-wavelength plate.

According still further to the first aspect of the invention, the exit-pupil expander may comprise: a substrate of optical material having a first surface and a second surface which is opposite to the first surface; an in-coupling diffractive element disposed on the first or the second surface of the substrate opposite to the scanning component; and one or more out-coupling diffractive elements disposed on the first or the second surface of the substrate, wherein the in-coupling diffractive element is configured to diffract the one or more input optical beams, so as to provide one or more diffracted optical beams within the first and second surfaces such that a portion of each of the one or more diffracted optical beam is coupled to a corresponding out-coupling diffractive element of the one or more out-coupling diffractive elements, and wherein each of the one or more out-coupling diffractive elements is configured to couple by diffraction a part of each of the one or more diffracted optical beams from the substrate for providing the one or more scanning near-to eye image displays with the expanded exit pupil. Still further, the apparatus may further comprise: one or more an intermediate diffractive elements, such that the at least part of each of the one or more input optical beams diffracted in the in-coupling diffractive element is first coupled to the one or more intermediate diffractive elements, which then couple, using a further diffraction in the one or more intermediate diffractive element, the at least part of each of the one or more the diffracted optical beams to the one or more further diffractive elements, to provide the one or more scanning near-to eye image displays with two-dimensional exit-pupil expansion. Yet still further, the in-coupling diffractive element may be a slanted diffraction grating. Further still, the in-coupling diffractive element may be configured to de-couple transverse electric and transverse magnetic polarizations.

According to a second aspect of the invention, a method, comprises: scanning by a scanning component one or more optical beams time modulated and synchronized with video information and providing one or more input optical beams by reflecting the one or more optical beams; and providing by an exit-pupil expander comprising a thin structure with a plurality of diffractive elements disposed on the thin structure, in response to the one or more optical beams, one or more output optical beams by using one or more diffractive elements from that plurality of diffractive elements, so as to provide one or more scanning near-to eye image displays with an expanded exit pupil for providing the video information.

According further to the second aspect of the invention, the providing the one or more output optical beams by the exit-pupil expander may comprise: receiving the one or more input optical beams by an in-coupling diffractive element disposed on a first or a second surface of a substrate opposite to the scanning mirror; diffracting the one or more input optical beams by the in-coupling diffractive element, so as to provide one or more diffracted optical beams within the first and second surfaces such that a portion of each of the one or more diffracted optical beam is coupled to a corresponding out-coupling diffractive element of the one or more out-coupling diffractive elements; and coupling by diffraction by each of the one or more out-coupling diffractive elements a part of each of the one or more diffracted optical beams from the substrate for providing the one or more scanning near-to eye image displays with the expanded exit pupil. Still further, the in-coupling diffractive element may be a slanted diffraction grating. Yet still further, the in-coupling diffractive element may be configured to de-couple transverse electric and transverse magnetic polarizations.

Further according to the second aspect of the invention, the one or more optical beams may be provided by corresponding one or more light sources. Further, the one or more light sources and the scanning component may be located on opposite sides of the exit-pupil expander. Still further, the one or more light sources may be provided using one or more optical fibers with corresponding one or more collimators. Yet still further, the one or more light sources may be provided using one or more light emitting diodes, or one or more lasers.

Still yet further according to the second aspect of the invention, the one or more output optical beams may have the expanded exit pupil in one or two dimensions relative to the input optical beam.

Still further still according to the second aspect of the invention, the scanning element may be a scanning mirror, configured to provide one or more input optical beams by reflecting the one or more optical beams.

According to a third aspect of the invention, an electronic device, comprises: a data processing unit; an optical engine operatively connected to the data processing unit for receiving image data from the data processing unit; a display device operatively connected to the optical engine for forming an image based on the image data; and a module comprising: a scanning component, configured to scan one or more optical beams time modulated and synchronized with video information and to provide one or more input optical beams; and an exit-pupil expander comprising a thin structure with a plurality of diffractive elements disposed on the thin structure, responsive to the one or more optical beams, configured to provide one or more output optical beams using one or more diffractive elements from that plurality of diffractive elements, so as to provide one or more scanning near-to eye image displays with an expanded exit pupil for providing the video information.

According further to the third aspect of the invention, the one or more optical beams may be provided by corresponding one or more light sources. Still further, the one or more light sources and the scanning component may be located on opposite sides of the exit-pupil expander.

Further according to the third aspect of the invention, the scanning element may be a scanning mirror, configured to provide one or more input optical beams by reflecting the one or more optical beams

### BRIEF DESCRIPTION OF THE DRAWINGS

For a better understanding of the nature and objects of the present invention, reference is made to the following detailed description taken in conjunction with the following drawings, in which:

FIG. 1 is a schematic representation of scanning near-to-eye (e.g., retinal) displaying with exit-pupil expansion using a scanning mirror and an exit-pupil expander with a light source and a mirror at opposite sides of the EPE plate, according to an embodiment of the present invention;

FIG. 2 is a schematic representation of scanning near-to-eye (e.g., retinal) displaying with exit-pupil expansion using a scanning mirror with polarization isolation components (a polarization beam splitter and a quarter-wave plate) and an exit-pupil expander, according to an embodiment of the present invention;

FIGS. 3a and 3b are schematic representations showing diffraction modes for scanning near-to-eye (e.g., retinal) displaying with exit-pupil expansion using a scanning mirror with a quarter-wave plate and an exit-pupil expander, according to an embodiment of the present invention;

FIGS. 4a-4d are graphs of simulated diffraction efficiencies of in-coupling diffraction gratings of FIGS. 3a and 3b using in-coupling diffraction element 14 shown in FIG. 3c, according to an embodiment of the present invention;

FIGS. 5a through 5c are schematic representations demonstrating modification of the scanning range using symmetrically positioned light sources: FIG. 5a is basic configuration with one source, and FIGS. 5b and 5c describe a configuration with two sources for increasing scanning range, according to an embodiment of the present invention.

FIG. 6 is a schematic representation of scanning near-to-eye (e.g., retinal) displaying with exit-pupil expansion using a scanning mirror with two light sources and an exit-pupil expander, according to an embodiment of the present invention;

FIGS. 7a and 7b are schematic representations (top views) of one area (left or right) of a two-dimensional diffractive exit-pupil expander, wherein an intermediate diffractive element (grating) has an odd number of first order diffractions (shown in FIG. 7a) or an even number of further first order reflections (shown in FIG. 7b), according to embodiments of the present invention;

FIG. 8 is a flow chart demonstrating performance of scanning near-to-eye (e.g., retinal) displaying with exit-pupil expansion using a scanning component and an exit-pupil expander, according to an embodiment of the present invention; and

FIG. 9 is a schematic representation of an electronic device, having scanning near-to-eye displaying with exit-pupil expansion, according to embodiments of the present invention.

### MODES FOR CARRYING OUT THE INVENTION

A new method and apparatus are presented for near-to-eye (e.g., retinal) displaying with exit-pupil expansion using a scanning component (e.g., a scanning mirror) and an exit-pupil expander, e.g., diffractive exit-pupil expander, for providing a retinal-scanning display with a large exit pupil. The embodiments of the present invention can be applied to a broad optical spectral range of optical beams but most importantly to a visible part of the optical spectrum where the optical beams are called light beams.

At a conceptual level, various embodiments of the present invention may combine the idea of the retinal scanning display with the diffractive exit-pupil expander to form a scanning-beam display with a large exit-pupil. At a technical level, the embodiments of the invention may provide a compact solution for implementation, e.g., of a MOEMS (micro (opto) electromechanical systems)—mirror-based scanning-beam display engine for the EPE plate.

According to various embodiments of the present invention, the scanning component may be implemented as a scanning mirror, an acousto-optical scanner, a light source which is moved (e.g., turned or rotated) through a desired angular sweep, or similar and emerging technologies for optical scanning.

Replacing a matrix display and imaging optics of a near-to-eye display (NED) with a scanning component such as MOEMS scanning mirror may reduce the weight and size of device, making it more comfortable to wear. The size and weight may further be reduced by moving the light source from the head unit, e.g., to a hip mounted battery box. The three primary colors may be combined in the battery box and the light may be coupled through an optical fiber that guides the light to the NED. The optical fiber may go side by side with the electrical wires that control the scanning mirror. Moreover, the scanning display does not need to have a constant illumination but just one light source that represents different pixels, depending on the mirror position. If the pixel is off (dark), the light source is off (dim). Therefore the average power consumption may be reduced and the image contrast may be improved. There are many ways how to place the scanning mirror and the light sources with respect to each other and the EPE plate, as illustrated herein.

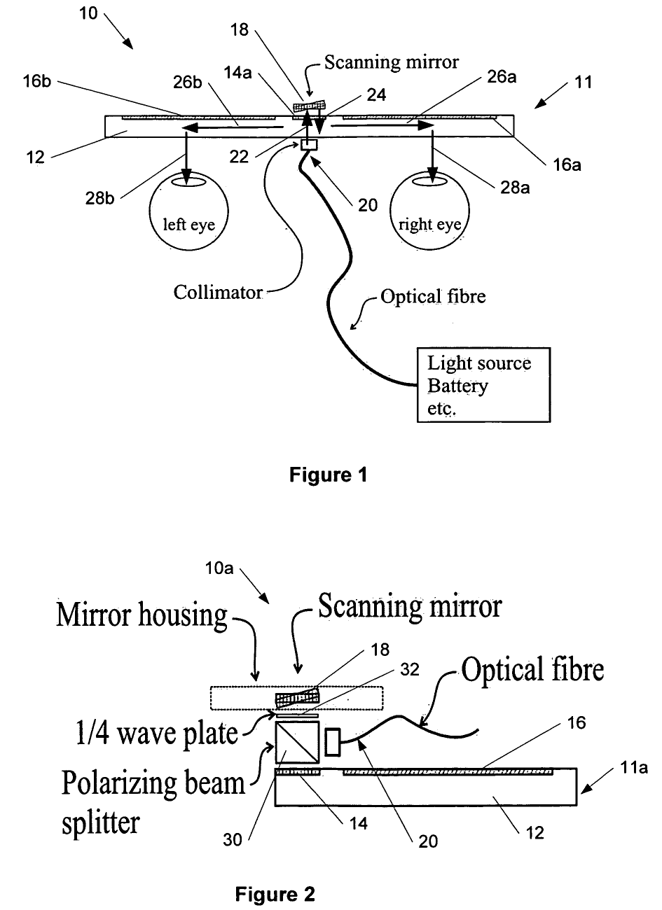

FIG. 1 shows one example among others of a schematic representation of an apparatus 10 for the scanning near-to-eye (e.g., retinal) displaying with the exit-pupil expansion using a scanning mirror 18 and an exit-pupil expander 11 (e.g., a diffractive exit-pupil expander) with a light source 20 and a mirror 18 at opposite sides of the EPE plate 11 (for binocular implementation as shown), according to an embodiment of the present invention.

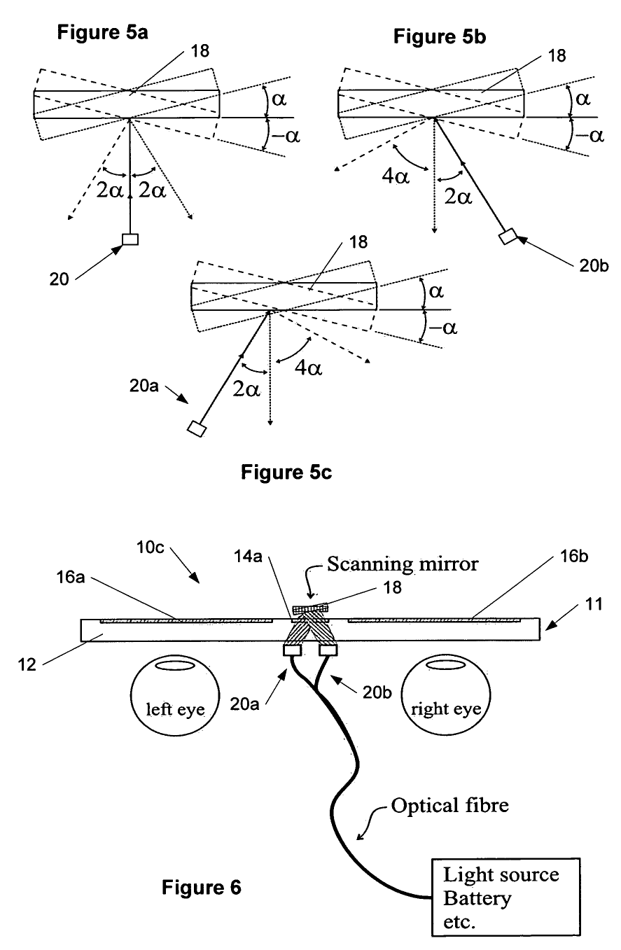

The usual optical engine used with EPEs is replaced by the point light source 20 and the MOEMS scanning mirror 18. The light source can be an LED, laser or the end of an optical fiber with a collimator (e.g., collimating lens or a collimating mirror) for providing a collimated optical beam. In case of the optical fiber implementation, the light source may be located, e.g., in a hip mounted battery box. As shown in FIG. 1, the scanning mirror 18 is located opposite to an input diffractive element (e.g., diffraction grating) 14a. The optical beam 22 from the light source 20 propagates through the EPE 11 (with some losses mostly due to diffraction and reflection) to the scanning mirror 18. The optical beam 22 is time modulated with video information (desired to be displayed) and synchronized with movement of the scanning mirror 18 (electrically controlled), so as to provide an input optical beam 24 (in general, it may be more than one input optical beam, see FIGS. 5a-5c and 6 for illustration) to the input diffractive element 14a by reflecting the optical beam 22.

The exit-pupil expander (e.g., see various embodiments shown in FIGS. 1, 2, 3a-3b, 6 and 7a-7b) may be configured, in response to one or more optical beams, to provide one or more output optical beams by diffraction, so as to provide one or more scanning near-to eye image displays with an expanded exit pupil for providing the video information, according to various embodiments. The exit-pupil expander may comprise (as shown in FIG. 1) a substrate of optical material 12 (in general it may be a thin structure) having a first surface and a second surface which is opposite to the first surface, an in-coupling diffractive element 14a disposed on the first or the second surface of the substrate 12 opposite to said scanning mirror 18, and one or more out-coupling diffractive elements (having at least one dimension larger than the in-coupling diffraction element for providing exit-pupil expansion) disposed on the first or the second surface of the substrate 12. In the example shown in FIG. 1 there are two out-coupling diffractive elements 16a and 16b, respectively, for providing binocular viewing.

The input diffractive element 14a in the example of FIG. 1, may be, for example, an asymmetric slanted diffraction grating, configured to provide, by diffracting the input optical beam 24, one or more diffracted optical beams (e.g., optical beams 26a and 26b in FIG. 1) within the first and second surfaces of the substrate 12 (e.g., by a total internal reflection) such that a portion of each of the one or more diffracted optical beams 26a and 26b is coupled to a corresponding out-coupling diffractive element 16a and 16b. The each of the out-coupling diffractive element 16a and 16b may couple by diffraction a part of each of the diffracted optical beams (beams 28a and 28b) from the substrate for providing two scanning near-to eye image displays with the expanded exit pupil.

It is noted that the important point is to enable parallel placement of the mirror 18 with respect to EPE plate 11 to allow for a compact construction. Moreover, it is critical that the center of rotation of the mirror 18 is as close to the in-coupling grating 14a of the EPE as possible. This is necessary to reduce beam shifts on the in-coupling grating 14a while scanning.

According to embodiments of the present invention, the in-coupling diffractive elements (or the in-coupling diffraction gratings) can be implemented using a variety of different types of diffraction gratings, e.g., planar diffraction gratings manufactured using lithographic methods or classically ruled (having different groove angles and profiles, such as binary, triangular, sinusoidal, etc.). The diffractive elements (i.e., their grooves) can be symmetric or asymmetric, e.g., using slanted gratings for increasing the coupling efficiency and reducing an “optical crosstalk” between left and right half spaces. For example, the slanted gratings can be asymmetric such that their slanting angles are equal but have opposite signs relative to the optical axis of the input optical beam, i.e., the groove shapes are mirror images of each other. Thus, grooves of the in-coupling diffractive element or the further in-coupling diffractive element can have an asymmetric groove shape and implemented, e.g., as slanted diffraction gratings.

It is noted that FIG. 1 provides an example of one embodiment utilizing a scanning mirror 18 as a scanning component (the same is applied to FIGS. 2, 3a-3b, 6). According to various embodiments of the present invention, the scanning component may be also implemented as an acousto-optical scanner, a light source which is moved (e.g., turned or rotated) through a desired angular range, or similar and emerging technologies for optical scanning.

It is further noted that generally the scanning mirror 18 can be means for scanning or a structural equivalence (or an equivalent structure) thereof. Furthermore, the exit-pupil expander 11 can generally be means for exit pupil expansion or a structural equivalence (or equivalent structure) thereof.

The main problem of the design shown in FIG. 1 is that the incident light from the optical fiber may be partially coupled into the EPE before hitting the MOEMS mirror 18 causing a spot of light to appear at a centre of the near-to eye image display. This may be reduced by a suitable selection of light polarization, grating profile, and the use of additional wave-plates. One such design to circumvent this problem is shown in FIG. 2.

FIG. 2 shows one example among others of a schematic representation of an apparatus 10a for the scanning near-to-eye (e.g., retinal) displaying with the exit-pupil expansion using the scanning mirror 18 with polarization isolation components (a polarization beam splitter 30 and a quarter-wave plate 32) and an exit-pupil expander 11a (with monocular implementation using an in-coupling diffractive element 14 and an out-coupling diffractive element 16), according to an embodiment of the present invention. The light source 20 and the scanning mirror 18 are located on the same side of the EPE 11a.

In general, the beam splitter may have a splitting ration of 50:50, which will couple only 25% of light to the EPE plate 11a. This can be increased by using a polarized light with the polarizing beam splitter 30, and the quarter-wave plate 32 in front of the mirror 18 to rotate the state of polarization as well known in the art. However, this approach increases the number of components required.

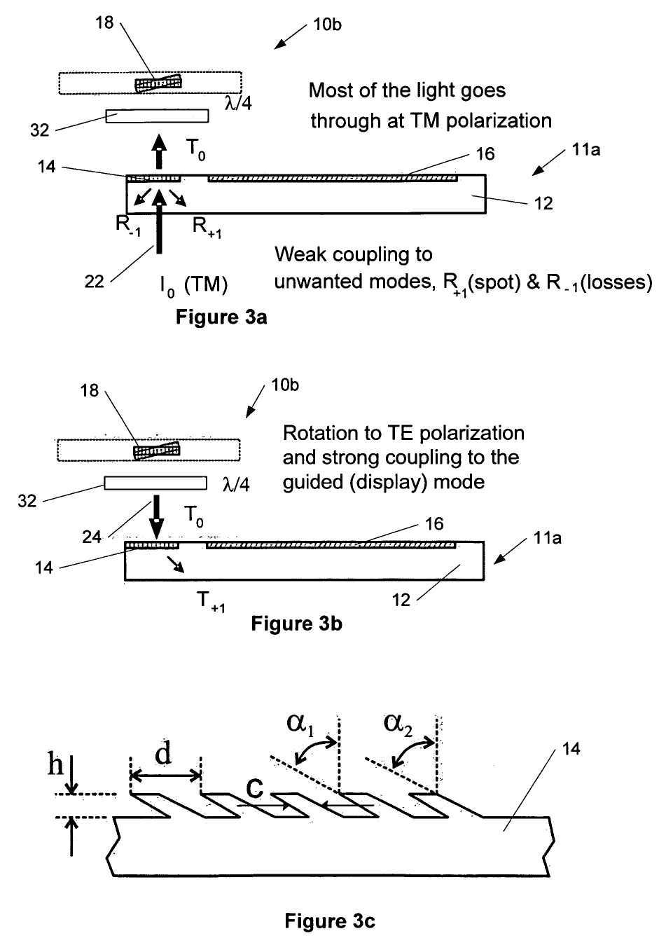

FIGS. 3a through 3c show an example among others of a schematic representations of an apparatus 10b showing diffraction modes for the scanning near-to-eye (e.g., retinal) displaying with the exit-pupil expansion using a scanning mirror 18 with a quarter-wave plate 32 and an exit-pupil expander 11a (with monocular implementation using the in-coupling diffractive element 14 and the out-coupling diffractive element 16), according to an embodiment of the present invention.

In FIG. 3a, the input beam 22 with TM polarization (electric field is perpendicular to the in-coupling grating grooves) propagates through the in-coupling diffractive element 14 (e.g., slanted diffraction grating shown in FIG. 3c) generating weak (since in-coupling grating 14 may be optimized for the TE mode) undesired diffraction modes R₊₁ (+1 reflected diffraction order, appears as a spot in the scanning image) and R₋₁ (−1 reflected diffraction order, losses) as shown in FIG. 3a. The most of propagated lights goes into a transmitted mode T₀ (0 transmitted diffracted order).

After reflecting from the scanning mirror 18 and propagating through the quarter-wave plate 32 two times, the beam 24 is TE polarized (electric field parallel with the grating grooves) as shown in FIG. 3b and it is coupled by the in-coupling diffractive element 14 with a strong coupling (e.g., diffraction mode T₀) to the EPE 11a.

FIG. 3c shows an example among others of a binary diffraction grating with a slanted profile which may be used as an in-coupling diffractive element 14 (shown in FIGS. 3a and 3b) with a grating period d=390 nm, a grating height h=300 nm, slanting angles α₁=α₂50 deg, a filling factor f=0.5 (c=d/2) and a refractive index of the material 1.71.

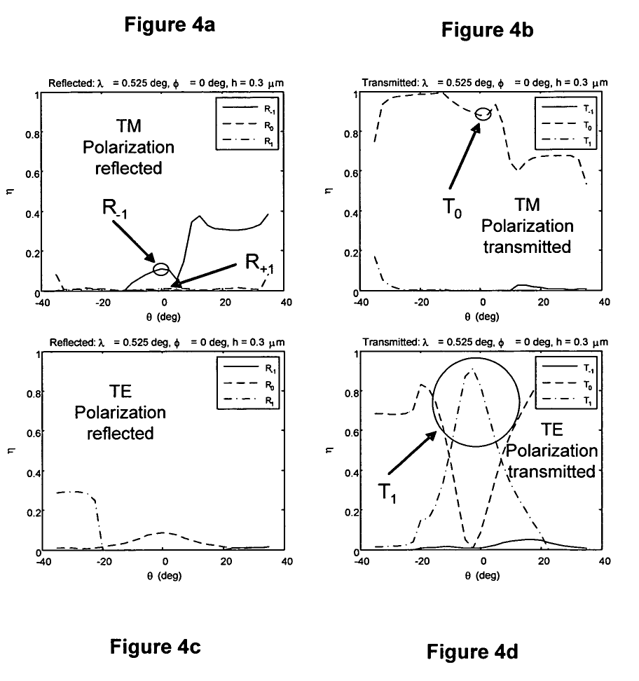

FIGS. 4a-4d shows example among others of graphs of simulated (e.g., using Rigorous Fourier Modal Method for multilayer surface relief gratings) diffraction efficiencies η as a function of incidence angle of the in-coupling diffraction grating for the schematic representations of FIGS. 3a and 3b using the in-coupling diffractive element (slanted binary diffractive grating) 14 shown in FIG. 3c, according to an embodiment of the present invention.

FIG. 4a shows diffraction efficiencies for TM polarization (electric field perpendicular to the grating grooves) for the reflected diffraction orders when the light is incident on the in-coupling grating 14 from the material side (optical beam 22 in FIG. 3a).

FIG. 4b shows diffraction efficiencies for TM polarization (electric field perpendicular to the grating grooves) for the transmitted diffraction orders when the light is incident on the in-coupling grating 14 from the material side (optical beam 22 in FIG. 3a).

FIG. 4c shows diffraction efficiencies for TE (transverse electric) polarization (electric field parallel with the grating grooves) for the reflected diffraction orders when the light is incident on the in-coupling grating 14 from air (optical beam 24 in FIG. 3b).

FIG. 4d shows diffraction efficiencies for TE (transverse electric) polarization (electric field parallel with the grating grooves) for the transmitted diffraction orders when the light is incident on the in-coupling grating 14 from air (optical beam 24 in FIG. 3b).

It is seen form FIGS. 4a-d that the in-coupling diffractive element 14 may be configured to asymmetrically de-couple transverse electric (TE) and transverse magnetic polarizations (TM).

Furthermore, according to another embodiment, the effective scanning angle of a scanning mirror may be increased by using more than one light source (e.g. two light sources). For example, the scanning angle of a scanning mirror may be doubled (without increasing the mechanical movement) by using two synchronous light sources; one light source covering the angles from Angleₘᵢₙ to 0° and the other source covers scanning angles from Angleₘₐₓ to 0°.

The configuration of using of multiple (two or more) light sources may be similar to that shown in FIG. 1. Instead of having one source we now may have multiple sources on the opposite side of the EPE with respect to the scanning mirror. The sources may be placed such that the input optical beams are at an angle with respect to the normal of the scanning mirror at the zero position. The separate beams are then turned on and off in synchronization with the mirror tilt angles.

FIGS. 5a through 5c shows an example among others of schematic representations demonstrating modification of the scanning range using symmetrically positioned light sources: FIG. 5a is basic configuration with one source, and FIGS. 5b and 5c describe a configuration with two sources for increasing scanning range, according to an embodiment of the present invention. The basic configuration is shown in FIG. 5a, where the angular scanning range is from −2α to 2 α. To increase the scanning range two light sources may be used in synchronization with the scanning mirror. The light sources may be placed symmetrically at both sides of the mirror and at angle with respect to the neutral position. Light sources may then be turned on and off so that the first half space is illuminated by first the light source (angles 0 to 4 α) and the second half space by the second light source (angles 0 to 4 α), as shown in FIGS. 5b and 5c. It is noted that this scheme allows doubling of the nominal scanning range of the mirror.

Moreover, the use of the two light sources enables the elimination of the zero angle spot that may be a problem for the basic configuration (e.g., shown in FIGS. 1 and 5a). In this case, the scanning range of the mirror is limited to a half of the nominal range. The possible spots due to the direct coupling of the emitted light beams into the EPE plate are then at the edges (or outside) of the virtual display area.

FIG. 6 show one example among others of a schematic representation of an apparatus 10c for the scanning near-to-eye (e.g., retinal) displaying with the exit-pupil expansion using the scanning mirror 18 with two light sources 20a and 20b, as discussed in reference to FIGS. 5b and 5c, and an exit-pupil expander 11 (with binocular implementation as in FIG. 1), according to an embodiment of the present invention.

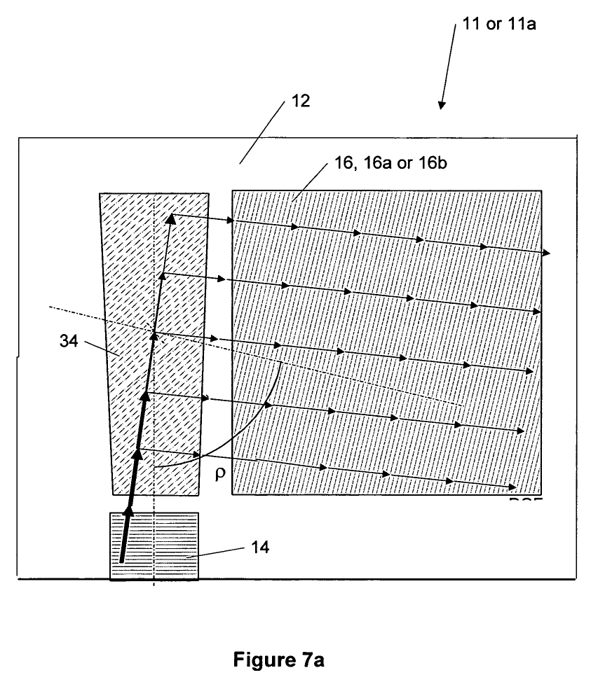

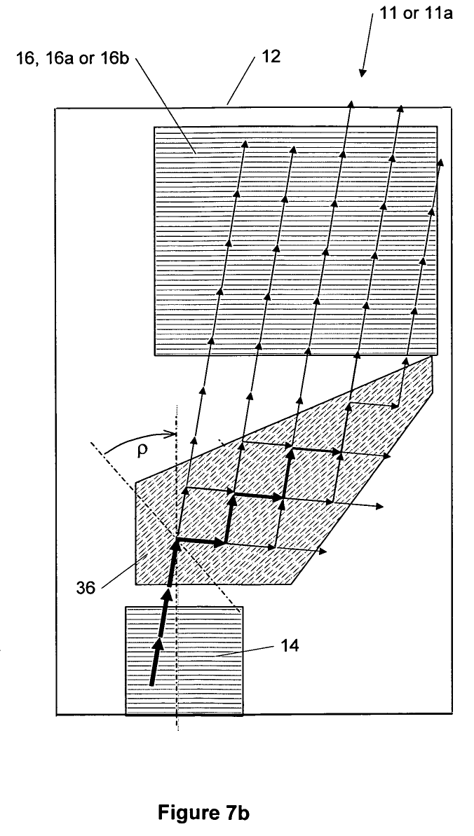

FIGS. 7a and 7b are schematic representations (top views) of one area (left or right) of a two-dimensional diffractive exit-pupil expander, wherein an intermediate diffractive element (grating) has an odd number of first order diffractions (shown in FIG. 7a) or an even number of further first order reflections (shown in FIG. 7b), according to embodiments of the present invention;

FIGS. 7a and 7b show examples among others of schematic representations (top views) of one area (left or right) of a two-dimensional diffractive exit-pupil expander according to embodiments of the present invention, wherein an intermediate diffractive element (grating) 34 or 36 has an odd number of first order diffractions (shown in FIG. 7a) or an even number of further first order reflections (shown in FIG. 7b), as described by T. Levola in “Diffractive Optics for Virtual Reality Displays”, SID Eurodisplay 05, Edinburg (2005), SID 02 Digest, Paper 22.1. The angle ρ is a rotation angle between the periodic lines of the intermediate diffraction grating 26 and the in-coupling grating 12-1 or 14-1, respectively. The grating and substrate numbers in FIGS. 7a and 7b correspond to the reference numbers of corresponding components shown in FIGS. 1, 2, 3a-3c and 6.

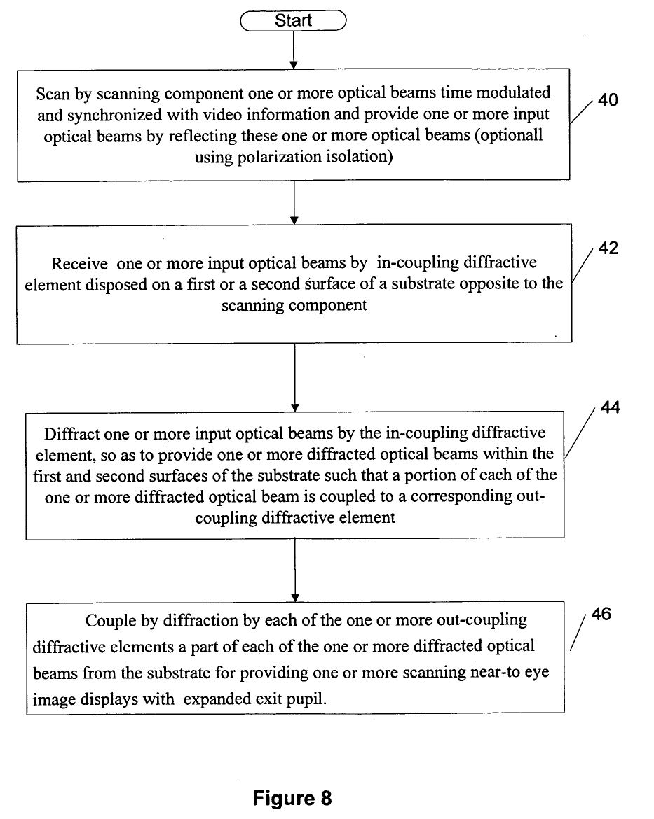

FIG. 8 shows an example among others of a flow chart demonstrating performance of the scanning near-to-eye (e.g., retinal) displaying with the exit-pupil expansion using a scanning component and an exit-pupil expander, according to an embodiment of the present invention.

The flow chart of FIG. 8 only represents one possible scenario among others. It is noted that the order of steps shown in FIG. 8 is not absolutely required, so in principle, the various steps can be performed out of order.

In a method according to the embodiment of the present invention, in a first step 40, a scanning (component (e.g., a mirror) may scan one or more optical beams time modulated and synchronized with video information and provide one or more input optical beams by reflecting these one or more optical beams (optionally using polarization isolation as described herein) In a next step 42, the in-coupling diffractive element (disposed on a first or a second surface of a substrate opposite to the scanning component) may receive one or more input optical beams.

In a next step 44, the one or more input optical beams may be diffracted by the in-coupling diffractive element, so as to provide one or more diffracted optical beams within the first and second surfaces of the substrate (e.g., using total internal reflection) such that a portion of each of the one or more diffracted optical beam is coupled to a corresponding out-coupling diffractive element (optionally using intermediate one or more diffractive elements).

In a next step 46, a part of each of the one or more diffracted optical beams is coupled by diffraction by each of the one or more out-coupling diffractive elements from the substrate for providing one or more scanning near-to eye image displays with expanded exit pupil.

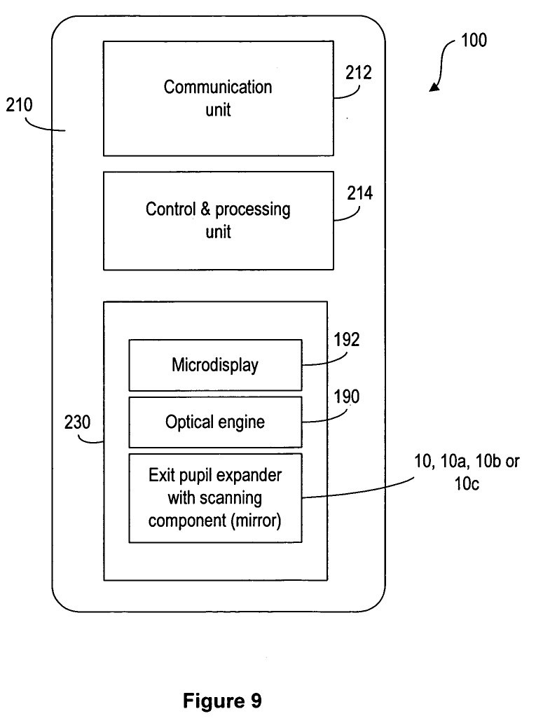

FIG. 9 shows an example of a schematic representation of an electronic device 100, having the exit-pupil expander with the scanning component (e.g., mirror) system 10 (10a, 10b or 10c), according to an embodiment of the present invention.

The system 10 (10a, 10b or 10c) can be used in an electronic (e.g., portable) device 100, such as a mobile phone, personal digital assistant (PDA), communicator, portable Internet appliance, hand-hand computer, digital video and still camera, wearable computer, computer game device, specialized bring-to-the-eye product for viewing and other portable electronic devices. As shown in FIG. 9, the portable device 100 has a housing 210 to house a communication unit 212 for receiving and transmitting information from and to an external device (not shown). The portable device 100 also has a controlling and processing unit 214 for handling the received and transmitted information, and a virtual display system 230 for viewing. The virtual display system 230 includes a micro-display or an image source 192 and an optical engine 190. The controlling and processing unit 214 is operatively connected to the optical engine 190 to provide image data to the image source 192 to display an image thereon. The EPE 10, according to the present invention, can be optically linked to an optical engine 190.

Furthermore, the image source 192, as depicted in FIG. 6, can be a sequential color LCOS (Liquid Crystal On Silicon) device, an OLED (Organic Light Emitting Diode) array, an MEMS (Micro Electro Mechanical System) device or any other suitable micro-display device operating in transmission, reflection or emission.

Moreover, the electronic device 100 can be a portable device, such as a mobile phone, personal digital assistant (PDA), communicator, portable Internet appliance, hand-held computer, digital video and still camera, wearable computer, computer game device, specialized bring-to-the-eye product for viewing and other portable electronic devices. However, the exit-pupil expander, according to an embodiment of the present invention, can also be used in a non-portable device, such as a gaming device, vending machine, band-o-matic, and home appliances, such as an oven, microwave oven and other appliances and other non-portable devices.

It is noted that various embodiments of the present invention recited herein can be used separately, combined or selectively combined for specific applications.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. An apparatus, comprising:
a scanning component, configured to scan one or more optical beams time modulated and synchronized with video information and to provide one or more input optical beams; and
an exit-pupil expander comprising a thin structure with a plurality of diffractive elements disposed on said thin structure, responsive to said one or more optical beams, configured to provide one or more output optical beams using one or more diffractive elements from that plurality of diffractive elements, so as to provide one or more scanning near-to eye image displays with an expanded exit pupil for providing said video information.

2. The apparatus of claim 1, wherein said one or more optical beams are provided by corresponding one or more light sources.

3. The apparatus of claim 2, wherein said one or more light sources and said scanning component are located on opposite sides of the exit-pupil expander.

4. The apparatus of claim 2, wherein said one or more light sources are provided using one or more optical fibers with corresponding one or more collimators.

5. The apparatus of claim 2, wherein said one or more light sources are provided using one or more light emitting diodes, or one or more lasers.

6. The apparatus of claim 1, wherein said one or more output optical beams have said expanded exit pupil in one or two dimensions relative to the input optical beam.

7. The apparatus of claim 1, wherein said scanning element is a scanning mirror, configured to provide one or more input optical beams by reflecting said one or more optical beams.

8. The apparatus of claim 7, further comprising:
a quarter-wavelength plate placed between said exit-pupil expander and said scanning mirror, configured to minimize light losses of the one or more optical beams coupled to said exit-pupil expander for providing said one or more scanning near-to eye image displays with the expanded exit pupil.

9. The apparatus of claim 8, further comprising:
a polarization beam splitter, configured to further minimize said light losses and placed between said quarter-wavelength plate and the exit-pupil expander, wherein said one or more optical beams are provided to said scanning mirror and to said exit-pupil expander using said polarization beam splitter and said quarter-wavelength plate.

10. The apparatus of claim 1, wherein said exit-pupil expander comprises:
a substrate of optical material having a first surface and a second surface which is opposite to the first surface;
an in-coupling diffractive element disposed on the first or the second surface of the substrate opposite to said scanning component; and
one or more out-coupling diffractive elements disposed on the first or the second surface of the substrate,
wherein said in-coupling diffractive element is configured to diffract the one or more input optical beams, so as to provide one or more diffracted optical beams within said first and second surfaces such that a portion of each of said one or more diffracted optical beam is coupled to a corresponding out-coupling diffractive element of said one or more out-coupling diffractive elements,
and wherein each of said one or more out-coupling diffractive elements is configured to couple by diffraction a part of each of said one or more diffracted optical beams from the substrate for providing said one or more scanning near-to eye image displays with the expanded exit pupil.

11. The apparatus of claim 10, further comprises:
one or more an intermediate diffractive elements, such that the at least part of each of the one or more input optical beams diffracted in the in-coupling diffractive element is first coupled to said one or more intermediate diffractive elements, which then couple, using a further diffraction in said one or more intermediate diffractive element, said at least part of each of the one or more said diffracted optical beams to said one or more further diffractive elements, to provide said one or more scanning near-to eye image displays with two-dimensional exit-pupil expansion.

12. The apparatus of claim 10, wherein said in-coupling diffractive element is a slanted diffraction grating.

13. The apparatus of claim 10, wherein said in-coupling diffractive element is configured to de-couple transverse electric and transverse magnetic polarizations.

14. A method, comprising:
scanning by a scanning component one or more optical beams time modulated and synchronized with video information and providing one or more input optical beams by reflecting said one or more optical beams; and
providing by an exit-pupil expander comprising a thin structure with a plurality of diffractive elements disposed on said thin structure, in response to said one or more optical beams, one or more output optical beams by using one or more diffractive elements from that plurality of diffractive elements, so as to provide one or more scanning near-to eye image displays with an expanded exit pupil for providing said video information.

15. The method of claim 14, wherein said providing by the exit-pupil expander comprises:
receiving said one or more input optical beams by an in-coupling diffractive element disposed on a first or a second surface of a substrate opposite to said scanning mirror;
diffracting the one or more input optical beams by said in-coupling diffractive element, so as to provide one or more diffracted optical beams within said first and second surfaces such that a portion of each of said one or more diffracted optical beam is coupled to a corresponding out-coupling diffractive element of said one or more out-coupling diffractive elements; and
coupling by diffraction by each of said one or more out-coupling diffractive elements a part of each of said one or more diffracted optical beams from the substrate for providing said one or more scanning near-to eye image displays with the expanded exit pupil.

16. The method of claim 15, wherein said in-coupling diffractive element is a slanted diffraction grating.

17. The method of claim 15, wherein said in-coupling diffractive element is configured to de-couple transverse electric and transverse magnetic polarizations.

18. The method of claim 14, wherein said one or more optical beams are provided by corresponding one or more light sources.

19. The method of claim 18, wherein said one or more light sources and said scanning component are located on opposite sides of the exit-pupil expander.

20. The method of claim 18, wherein said one or more light sources are provided using one or more optical fibers with corresponding one or more collimators.

21. The method of claim 18, wherein said one or more light sources are provided using one or more light emitting diodes, or one or more lasers.

22. The method of claim 14, wherein said one or more output optical beams have said expanded exit pupil in one or two dimensions relative to the input optical beam.

23. The method of claim 14, wherein said scanning element is a scanning mirror, configured to provide one or more input optical beams by reflecting said one or more optical beams.

24. An electronic device, comprising:
a data processing unit;
an optical engine operatively connected to the data processing unit for receiving image data from the data processing unit;
a display device operatively connected to the optical engine for forming an image based on the image data; and
a module comprising:
a scanning component, configured to scan one or more optical beams time modulated and synchronized with video information and to provide one or more input optical beams; and
an exit-pupil expander comprising a thin structure with a plurality of diffractive elements disposed on said thin structure, responsive to said one or more optical beams, configured to provide one or more output optical beams using one or more diffractive elements from that plurality of diffractive elements, so as to provide one or more scanning near-to eye image displays with an expanded exit pupil for providing said video information.

25. The electronic device of claim 24, wherein said one or more optical beams are provided by corresponding one or more light sources.

26. The electronic device of claim 25, wherein said one or more light sources and said scanning component are located on opposite sides of the exit-pupil expander.

27. The electronic device of claim 24, wherein said scanning element is a scanning mirror, configured to provide one or more input optical beams by reflecting said one or more optical beams.
